(19) United States
(12) Patent Application Publication
(10) Pub. No.: US 2023/0376295 A1
(43) Pub. Date: Nov. 23, 2023

(54) INFORMATION PROCESSING SYSTEM, CONTROL METHOD, AND STORAGE MEDIUM

(71) Applicant: CANON KABUSHIKI KAISHA, Tokyo (JP)

(72) Inventor: ATSUSHI IKEDA, Kanagawa (JP)

(21) Appl. No.: 18/317,700

(22) Filed: May 15, 2023

(30) Foreign Application Priority Data
May 19, 2022 (JP) 2022-082529

(51) Int. Cl. G06F 8/61; H04L 67/02

(52) U.S. Cl. CPC G06F 8/63; H04L 67/02

(57) ABSTRACT

There is provided a technique to avoid occurrence of useless download in an image generation system. In an information processing system enabling transmission of image data corresponding to a web page between an image generation system and a communication terminal, the image generation system inquires a free space of the communication terminal, inquires a size of a file to be downloaded, and in a case where the free space of the communication terminal is less than the size of the file, performs control not to download the file to be downloaded from an external web server.

### BACKGROUND

### Field of the Disclosure

The present disclosure relates to an information processing system, a control method, and a storage medium.

### Description of the Related Art

A communication terminal that is mounted with a web browser (hereinafter, browser) and has a function of enabling browsing of a web page on the browser has spread. A web page of an external service is displayed on the browser, which enables the communication terminal to cooperate with the external service.

Processing performed by the browser includes, as a standard specification, processing for a user to download a file stored in an external web service. Download of the file in the web service is realized by a file download element.

In the web page, the file download element is realized by description of <a href=[Uniform Resource Locator (URL)] download> (hereinafter, file download element). As the URL, a path where a file to be downloaded is stored is described.

In a case where the file download element is present in the web page, the browser displays a file download button in the web page. In a case where the user presses the button, the browser displays a download dialog. In a case where the user agrees to download, the browser downloads the file into an optional folder.

In recent years, the browser and a program other than the browser (hereinafter, the other program) are simultaneously used in many cases. As one of the cases, there is a form in which an area displayed by the browser is embedded in a part of an area displayed by the other program. Further, a method of downloading a file by drag and drop processing from the browser to the other program has been discussed (Japanese Patent Application Laid-Open No. 2015-32002).

### SUMMARY

Embodiments of the present disclosure relate to a file download element. According to embodiments of the present disclosure, there is provided an information processing system enabling transmission of image data corresponding to a web page between an image generation system and a communication terminal. The information processing system includes the image generation system, wherein the image generation system includes a free space inquiry unit configured to inquire a free space of the communication terminal, a file size inquiry unit configured to inquire a size of a file to be downloaded, and a control unit configured to perform control not to download the file to be downloaded from an external web server in a case where the free space of the communication terminal is less than the size of the file.

Further features of the present disclosure will become apparent from the following description of exemplary embodiments with reference to the attached drawings.

### BRIEF DESCRIPTION OF THE DRAWINGS

FIG. 1 is a hardware diagram of a virtual machine.

FIG. 2 is a configuration diagram of an image generation system and a communication terminal according to an exemplary embodiment of the present disclosure.

FIG. 3 is a flowchart illustrating a flow of processing by the image generation system according to the exemplary embodiment.

FIG. 4 is a flowchart illustrating a flow of processing by the communication terminal according to the exemplary embodiment.

FIGS. 5A and 5B each illustrate an example in which the processing according to the exemplary embodiment is implemented as a program.

FIG. 6 illustrates an example of a HyperText Transfer Protocol (HTTP) protocol response.

FIGS. 7A and 7B respectively illustrate a display example of a file download element and a display example of a download dialog.

FIGS. 8A and 8B respectively illustrate a display example in a case where download has succeeded and a display example in a case where download has failed.

FIG. 9 illustrates an example of data transmitted/received between the image generation system and the communication terminal.

FIG. 10 is a sequence diagram in a case of a download success.

### DESCRIPTION OF THE EMBODIMENTS

Exemplary embodiments of the present disclosure are described below with reference to drawings. The following exemplary embodiments do not limit the present disclosure, and all of combinations of features described in the present exemplary embodiment are not necessarily essential for solving means of the present disclosure. The same components are described while being denoted by the same reference numerals.

In a first exemplary embodiment, a case example in which, in a cloud browser, useless download is avoided by inquiring a free space of a communication terminal and inquiring a size of a file to be downloaded, of an external web server, is considered.

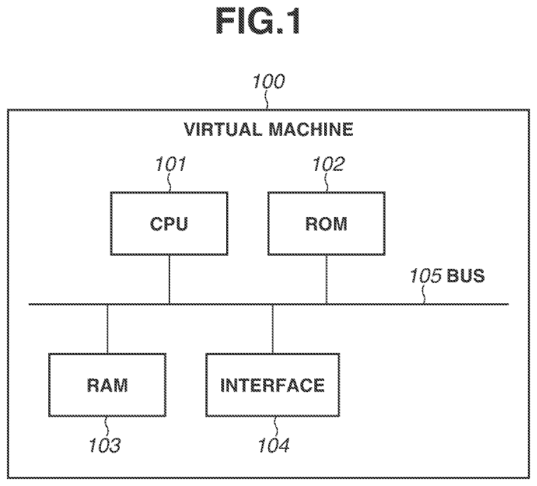

A configuration of a virtual machine mentioned in the present exemplary embodiment is described with reference to a block diagram in FIG. 1. In FIG. 1, a central processing unit (CPU) 101 controls a whole of a virtual machine 100. A read only memory (ROM) 102 stores programs and parameters requiring no change. A random access memory (RAM) 103 temporarily stores programs and data supplied from an external apparatus and the like. An interface 104 is to display held data and supplied data. A system bus 105 communicably connects the units 101 to 104. For example, an interface for a pointing device such as a mouse and an input device such as a keyboard that receive operation from a user to input data may be provided. Further, a hard disk drive, a memory card, and the like may be virtually fixed and installed in the virtual machine 100. Alternatively, an external storage device virtually detachable from the virtual machine 100, for example, a flexible disk (FD), an optical disk such as a compact disk (CD), a magnetic or optical card, an integrated circuit (IC) card, and a memory card may be provided. A network interface for connection to a network line such as the Internet may be further provided.

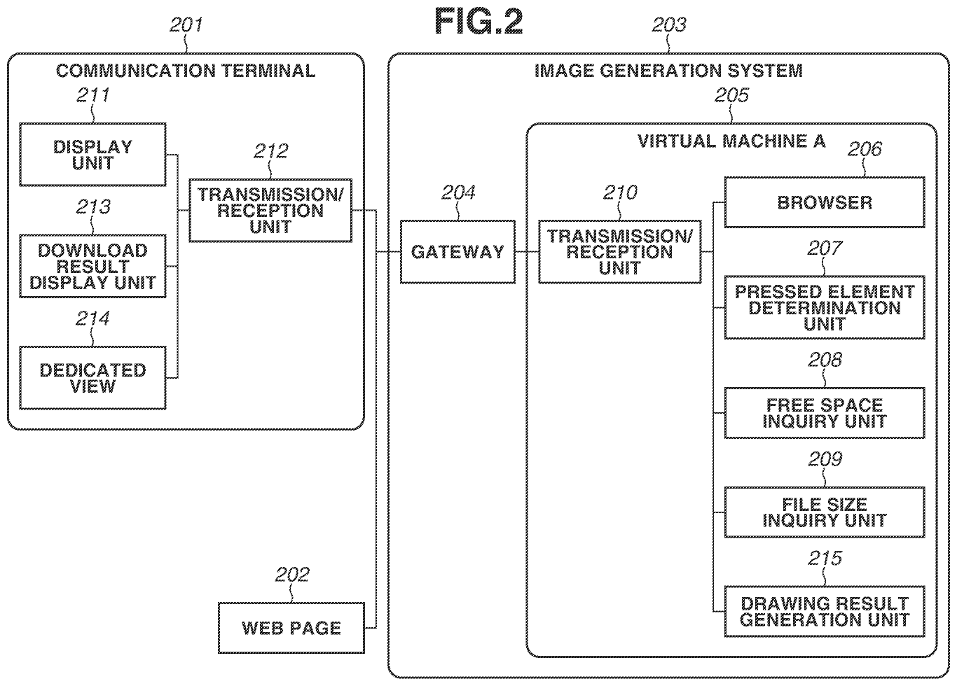

Next, a configuration of the cloud browser according to the present exemplary embodiment is described with reference to FIG. 2. FIG. 2 illustrates configurations of an image generation system and a communication terminal according to the present exemplary embodiment.

In FIG. 2, a communication terminal 201 and an image generation system 203 are illustrated. In the present exemplary embodiment, the image generation system indicates the cloud browser. Further, the entire system is called an information processing system.

A user browses a screen of the communication terminal 201. The communication terminal 201 transmits a uniform resource locator (URL) of a web page 202 that the user desires to browse, to the image generation system 203 through a transmission/reception unit 212.

Next, the image generation system 203 accesses the web page 202, and generates a drawing result by a drawing result generation unit 215. Thereafter, in a case where acquisition of the drawing result is requested from the communication terminal 201, the image generation system 203 returns the generated drawing result to the communication terminal 201 through a transmission/reception unit 210. The communication terminal 201 receives the drawing result through the transmission/reception unit 212, and presents the drawing result to the user by a display unit 211.

The image generation system 203 includes a gateway 204 and a virtual machine A 205. A browser 206 generating the drawing result operates on the virtual machine A 205. The browser 206 is a so-called browser engine, and performs analysis of HyperText Markup Language (HTML), JavaScript®, cascading style sheets (CSS), and the like, and processing relating to a user operation or a communication event. Communication between the communication terminal 201 and the virtual machine A 205, and communication between the web page 202 and the virtual machine A 205 are performed through the gateway 204.

A pressed element determination unit 207 of the virtual machine A 205 determines whether a user has pressed a file download element included in the web page 202 displayed on the browser 206, based on a user operation instruction received from the communication terminal 201.

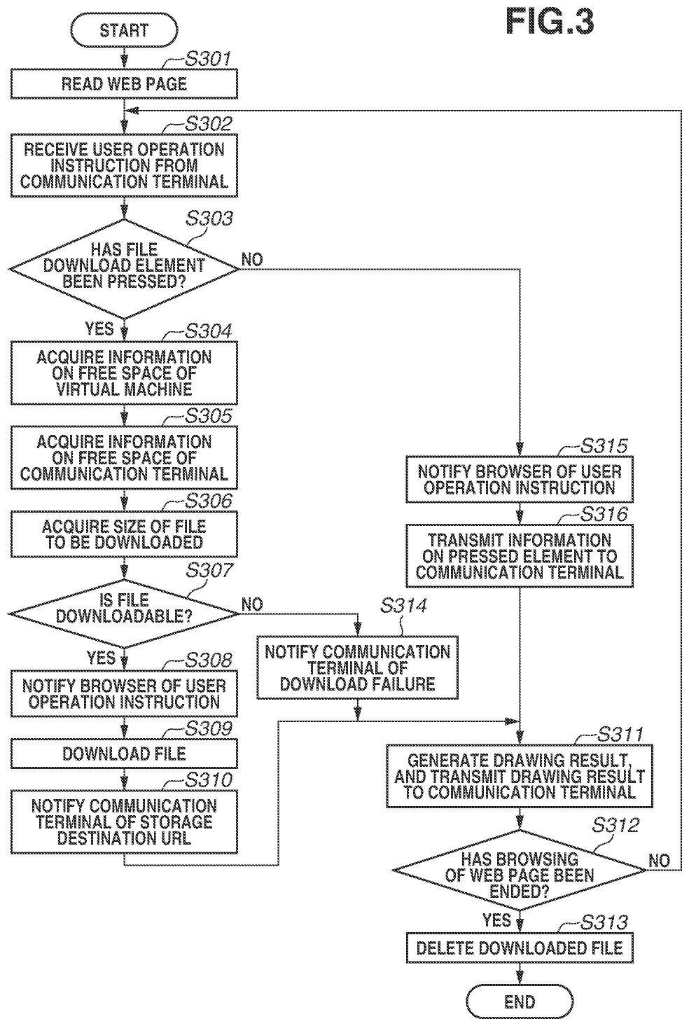

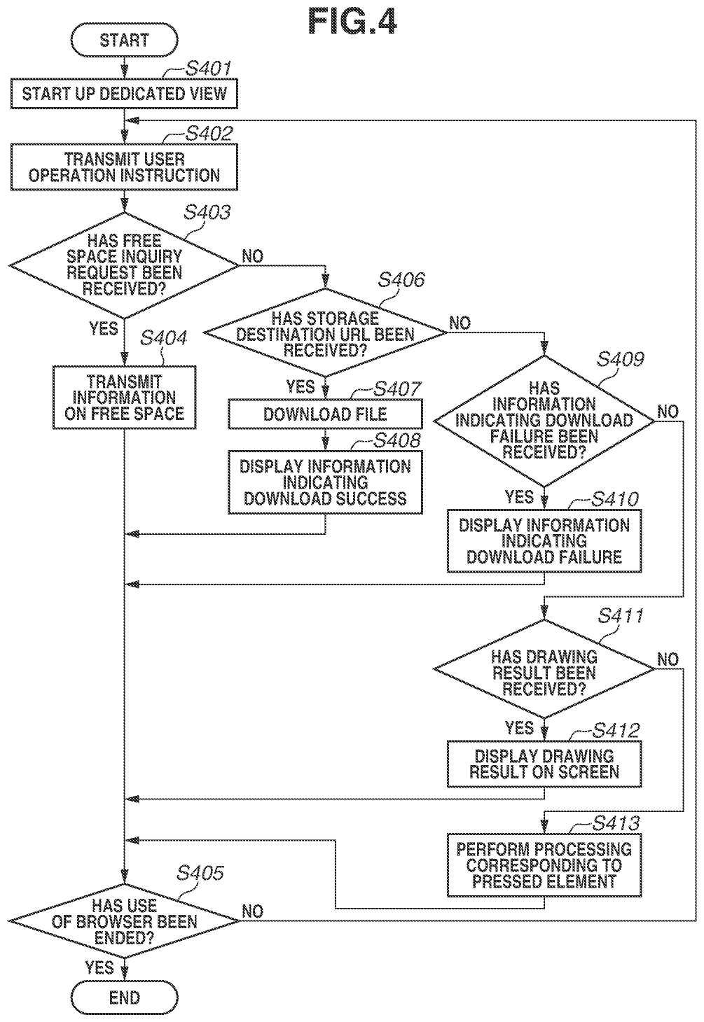

Further, a free space inquiry unit 208 inquires a free space to the communication terminal 201. A file size inquiry unit 209 inquires a size of a file to be downloaded, to the external web server. FIG. 3 and FIG. 4 are flowcharts according to the present exemplary embodiment. FIG. 3 illustrates a processing flow by the image generation system 203, and FIG. 4 illustrates a processing flow by the communication terminal 201.

In the present exemplary embodiment, in step S301, a URL of the web page notified from the communication terminal 201 is first read. At this time, the image generation system 203 transmits a drawing result (image data corresponding to web page) to the communication terminal 201. Subsequently, in step S302, a user operation instruction notified from the communication terminal 201 is received. The user operation instruction includes information indicating an attribute of operation, for example, “tap” operation that is touch of a terminal screen by a finger and “key input” operation that is depression of a keyboard provided on the terminal. Further, the user operation instruction includes information accompanying each attribute of the operation, for example, xy coordinates indicating a place of the screen touched by the user, and a value of a key depressed by the user. The URL of the web page and the operation instruction reach the browser 206 through the gateway 204 and the transmission/reception unit 210.

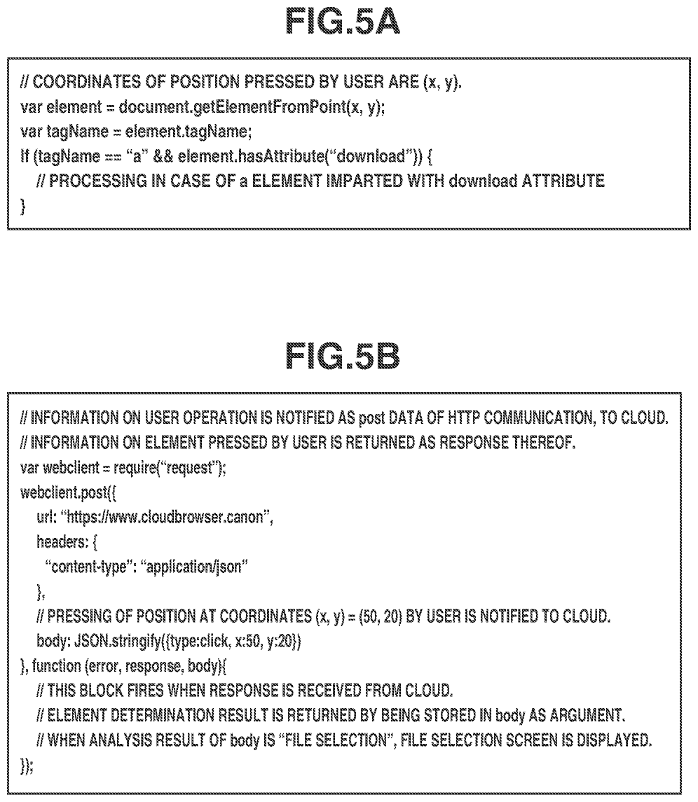

A method of transmitting the user operation instruction from the communication terminal 201 to the image generation system 203 in the present exemplary embodiment is described with reference to FIG. 5B. FIG. 5B illustrates a JavaScript® program to store the user operation instruction in BODY of HTTP communication. In FIG. 5B, “webclient” is a structure to transmit an HTTP communication request to a communication destination. A request destination can be designated by a url member, and a value thereof is “https://www.cloudbrowser.canon”. Further, body of the request can be designated by a body member, and a value thereof is {type:click, x:50, y:20}, where “type:click” indicates that the user operation is click. In addition, “x:50” indicates that the x coordinate clicked by the user is 50, and “y:20” indicates that the y coordinate clicked by the user is 20.

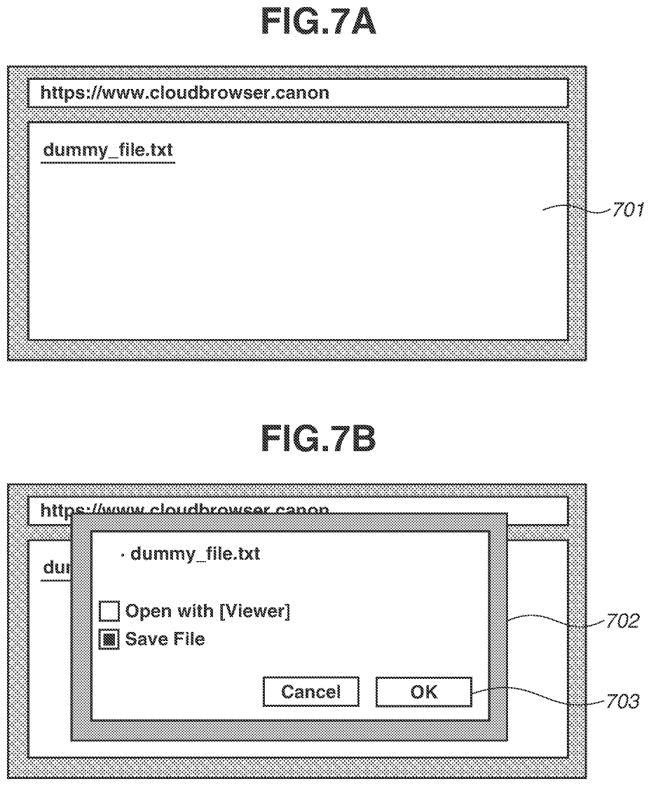

Subsequently, in step S303, the pressed element determination unit 207 determines whether the element pressed by the user is the file download element. A display example of the file download element and a display example of a download dialog based on a web standard specification are described with reference to FIGS. 7A and 7B.

FIG. 7A illustrates a web page including the file download element. In FIG. 7A, the file download element is a link 701 displayed as “dummy_file.text”. In a case where it is determined that the user has pressed the link 701, the browser 206 starts up the download dialog. FIG. 7B illustrates a calling result of the download dialog. A download dialog 702 is illustrated. In the example of FIG. 7B, it is inquired of the user whether to download “dummy_file.text”. In a case where the user agrees to the download, the user presses an OK button 703.

Subsequently, the determination method in step S303 is described with reference to FIG. 5A. FIG. 5A illustrates a JavaScript® program to determine the file download element. A function “document.getElementFromPoint(x, y);” is a function extracting an element at the xy coordinates. The element present at the position (x, y) tapped by the user is known from the function. Further, “element.tagName;” indicates an element name, and “element.hasAttribute(“download”)” checks whether a download attribute has been imparted to a target element. In the present exemplary embodiment, in a case where the element name is “input” and the download attribute has been imparted to the element, it is determined that the element pressed by the user is the file download element.

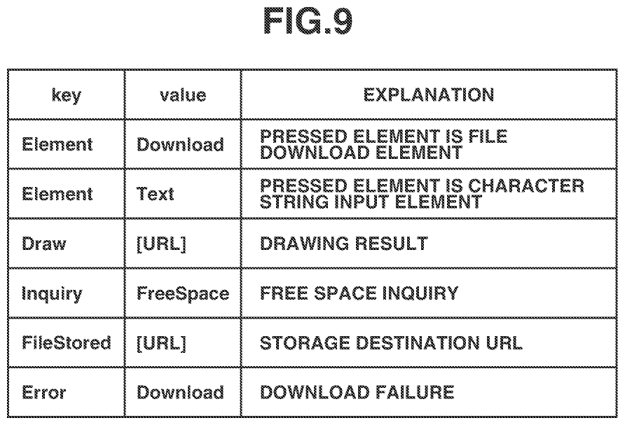

Subsequently, information indicating that the element pressed by the user is the file download element is described with reference to FIG. 9. FIG. 9 illustrates an example of data transmitted/received between the image generation system 203 and the communication terminal 201. It is known from FIG. 9 that, in a case where information transmitted/received between the communication terminal 201 and the image generation system 203 is “key=Element, value=Download”, the pressed element is the file download element. In step S303, in a case where the element pressed by the user is the file download element, a character string “key=Element, value=Download” is transmitted from the image generation system 203 to the communication terminal 201.

In contrast, in a case where the element pressed by the user is not the file download element as a result of the determination in step S303 (NO in step S303), the processing proceeds to step S315.

In a case where the element pressed by the user is the file download element as the result of the determination in step S303 (YES in step S303), a free space of the virtual machine is acquired in step S304.

Subsequently, in step S305, the free space inquiry unit 208 transmits a free space inquiry request to the communication terminal 201 through the transmission/reception unit 210. In step S305, the communication terminal 201 can determine whether the request is the free space inquiry request, based on correspondence of the information to be transmitted/received with the element type, previously determined between the communication terminal 201 and the image generation system 203.

A method of determining the correspondence of the information to be transmitted/received with the inquiry request is described with reference to FIG. 9. In FIG. 9, a key column, a value column, and an explanation column are present. The key column indicates an attribute of the information, and the value column indicates a value of the attribute. The table in FIG. 9 is held by each of the communication terminal 201 and the image generation system 203.

For example, it is assumed that, in step S305, the transmission/reception unit 210 transmits a character string “key=Inquiry, value=FreeSpace” to the communication terminal 201. In this case, “free space inquiry” is described in the explanation column corresponding to “key=Inquiry, value=FreeSpace”, and the communication terminal 201 can know that the free space inquiry request has received from the image generation system 203.

Subsequently, in step S306, the file size inquiry unit 209 acquires the size of the file to be downloaded, from the external web server through the transmission/reception unit 210. In the present exemplary embodiment, in step S306, a HEAD method of the HTTP protocol is used. In the HEAD method of the HTTP protocol, only HEAD data storing information on the target file is acquired, and BODY data that is the data on the target file is not acquired.

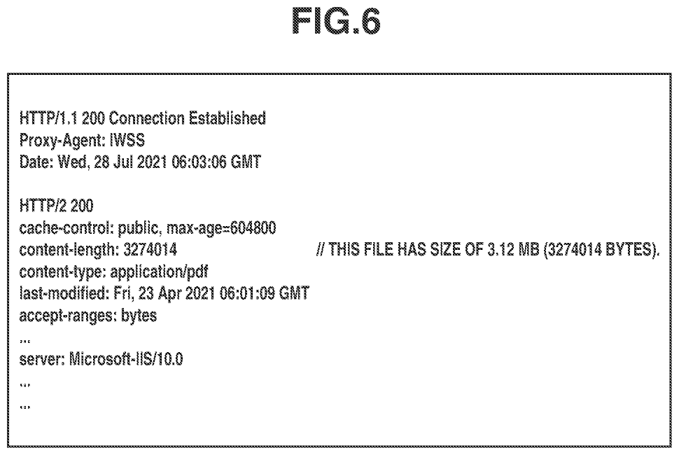

FIG. 6 illustrates an example of the HEAD data. In FIG. 6, “content-length: 3274014” is displayed, and “content-length” is a value indicating the size of the target file. Accordingly, it is known from FIG. 6 that the size of the target file is 3274014 bytes.

Subsequently, in step S307, it is determined whether the file to be downloaded is downloadable. In the present exemplary embodiment, the free space of the virtual machine A 205 acquired in step S304 and the free space of the communication terminal 201 acquired in step S305 are both used in step S307.

The free space of the virtual machine A 205 acquired in step S304 and the size of the file to be downloaded acquired in step S306 are compared to determine whether the free space of the virtual machine A 205 is greater than the size of the file to be downloaded. In a case where the free space of the virtual machine A 205 is less than the size of the file to be downloaded, it is determined that the file to be downloaded is not downloadable. Subsequently, the free space of the communication terminal 201 acquired in step S305 and the size of the file to be downloaded acquired in step S306 are compared to determine whether the free space of the communication terminal 201 is greater than the size of the file to be downloaded. In a case where the free space of the communication terminal 201 is less than the size of the file to be downloaded, it is determined that the file to be downloaded is not downloadable.

In a case where it is determined that the file to be downloaded is downloadable in step S307 (YES in step S307), the processing proceeds to step S308. In contrast, in a case where it is determined that the file to be downloaded is not downloadable in step S307 (NO in step S307), the processing proceeds to step S314.

In step S308, the user operation instruction received in step S302 is notified to the browser 206. In response thereto, the browser 206 downloads the target file according to the web standard specification in step S309.

Subsequently, in step S310, the image generation system 203 notifies the communication terminal 201 of a storage destination URL where the file downloaded in step S309 is stored, through the transmission/reception unit 210. Information indicating the storage destination URL is described with reference to FIG. 9. In FIG. 9, “storage destination URL” is described in the explanation column corresponding to “key=FileStored, value=[URL]”, and the communication terminal 201 can know that the storage destination URL has received from the image generation system 203. In [URL] in FIG. 9, a character string of an optional URL is entered. This enables the communication terminal 201 to receive the file to be downloaded, from the image generation system 203.

In contrast, in step S314, a download failure is notified to the communication terminal 201. Information indicating the download failure is described with reference to FIG. 9. It is found from FIG. 9 that, in a case where the information transmitted/received between the communication terminal 201 and the image generation system 203 is “key=Error, value=Download”, download has failed. In step S314, a character string “key=Error, value=Download” is transmitted from the image generation system 203 to the communication terminal 201.

Subsequently, in step S311, the drawing result generation unit 215 generates a drawing result, and transmits the drawing result to the communication terminal 201. Thereafter, in step S312, it is determined whether browsing of the web page has been ended. In a case where browsing of the web page has been ended as a result of the determination in step S312 (YES in step S312), the file downloaded in step S309 is deleted from a storage area of the virtual machine A 205 in step S313. In step S313, the file is deleted in terms of information confidentiality. Therefore, in a case where the file downloaded in step S309 is continuously used in the virtual machine A 205, the file may not be deleted.

In a case where the element pressed by the user is not the file download element as a result of the determination in step S303 (NO in step S303), the pressed element determination unit 207 notifies the browser 206 of the user operation instruction in step S315.

Subsequently, in step S316, the transmission/reception unit 210 transmits information on the pressed element to the communication terminal 201. The processing in steps S315 and S316 is not processing unique to the present exemplary embodiment, and is processing performed in an existing cloud browser.

Next, the processing flow by the communication terminal 201 is described with reference to FIG. 4. In step S401, the communication terminal 201 first starts up the dedicated view 214. At this time, the communication terminal 201 transmits a URL of the web page 202 desired to be displayed, to the image generation system 203.

The dedicated view 214 mainly has two functions. One of the functions is a function of displaying the drawing result received from the image generation system 203. The other function is a function of receiving the user operation instruction and transmitting the user operation instruction to the image generation system 203.

Next, in step S402, the dedicated view 214 transmits the user operation instruction to the image generation system 203 through the transmission/reception unit 212. The user operation instruction transmitted in step S402 is used in step S302 of the processing flow by the image generation system 203.

Next, in step S403, it is determined whether the information received by the transmission/reception unit 212 from the image generation system 203 is the free space inquiry request. The free space inquiry request is the character string “key=Inquiry, value=FreeSpace”.

Subsequently, in a case where the free space inquiry request has been received as a result of the determination in step S403 (YES in step S403), the transmission/reception unit 212 transmits the free space of the communication terminal 201 to the image generation system 203 in step S404. In contrast, in a case where the free space inquiry request has not been received as the result of the determination in step S403 (NO in step S403), the processing proceeds to step S406.

Subsequently, in step S405, it is determined whether the user has ended use of the cloud browser. In a case where the user has ended use of the cloud browser as a result of the determination in step S405 (YES in step S405), the processing ends. In contrast, in a case where the user continues use of the cloud browser as the result of the determination in step S405 (NO in step S405), the processing proceeds to step S402.

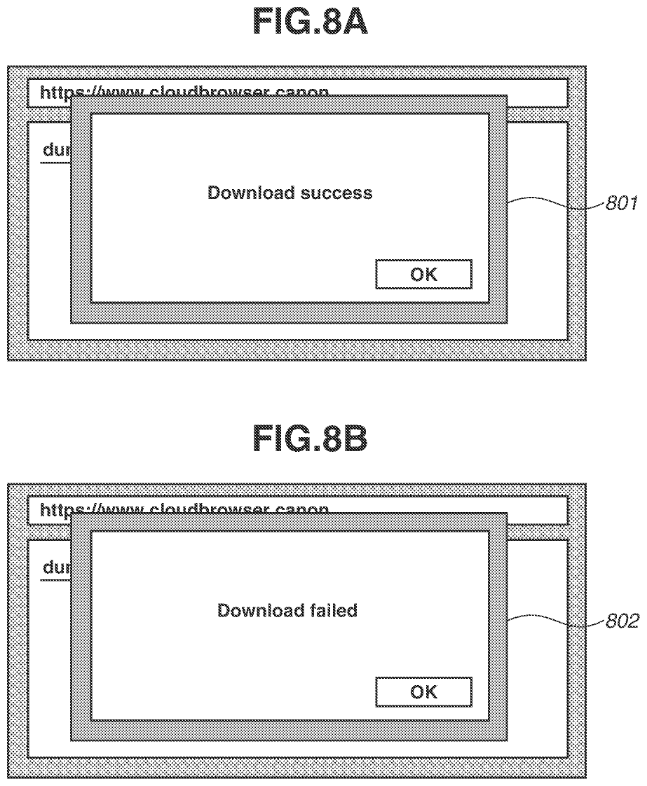

In a case where the free space inquiry request has not been received in step S403, it is determined whether the information received by the transmission/reception unit 212 from the image generation system 203 is the storage destination URL in step S406. In a case where the received information is the storage destination URL as a result of the determination in step S406 (YES in step S406), a file is downloaded from the storage destination URL in step S407. Subsequently, in step S408, the display unit 211 displays information indicating a download success, on a screen. FIG. 8A illustrates a display example in step S408. In FIG. 8A, information 801 is the information indicating the download success. Note that, at the same time when the storage destination URL is notified from the image generation system 203 to the communication terminal 201, a download progress rate may be shared. At this time, the communication terminal 201 may display download progress indicating a downloaded degree, on the screen.

In contrast, in a case where the received information is not the storage destination URL as the result of the determination in step S406 (NO in step S406), it is determined whether the information received from the image generation system 203 is the information indicating the download failure in step S409. In a case where the information indicating the download failure has been received as a result of the determination in step S409 (YES in step S409), the display unit 211 displays the information indicating the download failure, on the screen in step S410.

FIG. 8B illustrates a display example in step S410. In FIG. 8B, information 802 is the information indicating the download failure. In the present exemplary embodiment, the screen indicating the download failure is read out from screens stored in the communication terminal 201.

In a case where the information indicating the download failure has not been received in step S409 (NO in step S409), it is determined whether the drawing result has been received in step S411. In a case where the drawing result has been received as a result of the determination in step S411 (YES in step S411), the display unit 211 displays the drawing result on the screen in step S412. In contrast, in a case where the drawing result has not been received as the result of the determination in step S411 (NO in step S411), the processing proceeds to step S413.

Next, in the case where the drawing result has not been received as the result of the determination in step S411, processing corresponding to the pressed element is performed in step S413. Examples of the corresponding processing in step S413 include processing for displaying a software keyboard on the screen of the communication terminal 201, by the display unit 211.

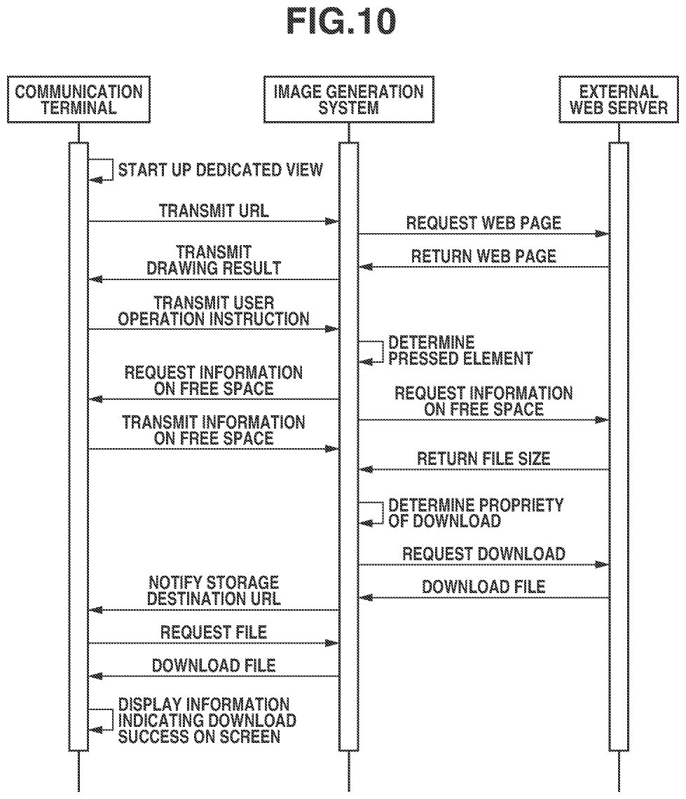

Subsequently, a processing sequence among the communication terminal 201, the image generation system 203, and the external web server is described with reference to FIG. 10. FIG. 10 illustrates the sequence in a case of the download success.

First, in step S401, the communication terminal 201 starts up the dedicated view 214, and transmits the URL of the web page 202 desired to be displayed, to the image generation system 203. The image generation system 203 requests the web page 202 to the external web server based on the received URL. Thereafter, the external web server returns the web page 202. In step S301, the image generation system 203 draws the acquired web page 202, and transmits a drawing result to the communication terminal 201.

Subsequently, in step S402, the user operation instruction is transmitted from the communication terminal 201 to the image generation system 203. In step S303, the image generation system 203 determines the element pressed by the user based on the instruction. In the case where the pressed element is the file download element, the image generation system 203 requests information on the free space to the communication terminal 201 in step S305. Subsequently, in step S306, the image generation system 203 requests the size of the file to be downloaded, to the external web server. The processing in steps S305 and S306 may be asynchronously performed so as to issue the request without waiting response as illustrated in FIG. 10, or may be synchronously performed so as to perform processing after the response to the request is returned.

Subsequently, in step S404, the communication terminal 201 transmits the information on the free space to the image generation system 203. Further, the external web server transmits the size of the file to be downloaded, to the image generation system 203. Thereafter, in step S307, the image generation system 203 determines whether the file is downloadable.

In a case where the file is downloadable in step S307, the image generation system 203 downloads the file to be downloaded, from the external web server. Thereafter, in step S310, the storage destination URL where the file to be downloaded is stored, is notified.

Further, in step S407, the communication terminal 201 acquires the file from the received storage destination URL. Thereafter, in step S408, the communication terminal 201 displays the information indicating the download success, on the screen.

The present exemplary embodiment makes it possible to avoid occurrence of useless download between the external web service and the image generation system, in the cloud browser.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-082529, filed May 19, 2022, which is hereby incorporated by reference herein in its entirety.

What is claimed is:

1. An information processing system enabling transmission of image data corresponding to a web page between an image generation system and a communication terminal, the information processing system comprising:
the image generation system, wherein the image generation system includes:
a free space inquiry unit configured to inquire a free space of the communication terminal;
a file size inquiry unit configured to inquire a size of a file to be downloaded; and
a control unit configured to perform control not to download the file to be downloaded from an external web server in a case where the free space of the communication terminal is less than the size of the file.

2. The information processing system according to claim 1, wherein, in a case where an element pressed by a user is a file download element, the image generation system performs inquiry by the free space inquiry unit.

3. The information processing system according to claim 1, wherein, in a case where an element pressed by a user is a file download element, the image generation system performs inquiry by the file size inquiry unit.

4. The information processing system according to claim 1, wherein the image generation system acquires information on a free space of the image generation system, and in a case where the free space of the image generation system is greater than the size of the file to be downloaded, the image generation system downloads the file to be downloaded.

5. The information processing system according to claim 1, wherein the image generation system further includes a communication unit configured to notify, after the file to be downloaded is downloaded, the communication terminal of a storage destination uniform resource locator (URL) indicating a place where the downloaded file is stored.

6. The information processing system according to claim 1, wherein the image generation system further includes a transmission unit configured to transmit, in a case where the file to be downloaded is not downloaded, information indicating a download failure to the communication terminal.

7. The information processing system according to claim 6, wherein the communication terminal includes a display unit configured to display, in a case where the information indicating the download failure is received from the image generation system, the information indicating the download failure, on a screen.

8. The information processing system according to claim 1, wherein the communication terminal includes a download unit configured to download, in a case where a storage destination URL is received from the image generation system, a file from the storage destination URL.

9. The information processing system according to claim 8, wherein the communication terminal includes a display unit configured to display information indicating a download success on a screen after the file is downloaded from the storage unit URL.

10. A method of controlling an information processing system enabling transmission of image data corresponding to a web page between an image generation system and a communication terminal, the method comprising, in the image generation system:
inquiring a free space of the communication terminal;
inquiring a size of a file to be downloaded; and
performing control not to download the file to be downloaded from an external web server in a case where the free space of the communication terminal is less than the size of the file.

11. A non-transitory computer-readable storage medium storing one or more programs including instructions for causing a computer to perform the method according to claim 10.
